(19) United States
(12) Patent Application Publication
(10) Pub. No.: US 2012/0155229 A1
(43) Pub. Date: Jun. 21, 2012

(54) Decorative part, timepiece, and manufacturing method of decorative part

(76) Inventors: Akiko Araki, Chiba-shi (JP); Takashi Niwa, Chiba-shi (JP); Takuya Murazumi, Chiba-shi (JP); Matsuo Kishi, Chiba-shi (JP)

(21) Appl. No.: 13/374,137

(22) Filed: Dec. 13, 2011

(30) Foreign Application Priority Data
Dec. 16, 2010 (JP) 2010-281039

(51) Int. Cl. G04B 47/04; B23P 11/00; B32B 3/06

(52) U.S. Cl. 368/285; 428/99; 29/428

(57) ABSTRACT

A decorative part, a timepiece, and a manufacturing method of the decorative part capable of stabilizing and improving the aesthetic appearance while using a fixing member are provided. In an oscillating weight which includes a body of an oscillating weight and screws for fixing the body of the oscillating weight to a weight, the body of the oscillating weight and the screws are a member to which an anodizing can be applied.

### BACKGROUND OF THE INVENTION

1. Field of the Invention

The present invention relates a decorative part, a timepiece using the decorative part, and a manufacturing method of the decorative part.

2. Description of the Related Art

For example, in an automatic winding mechanism mounted on an automatic winding watch, an oscillating weight having a body of an oscillating weight and the weight is moved by the movement of the arm of a user, and the mainspring of a movement barrel wheel is wound up. As the oscillating weight, there is an oscillating weight in which the body of the oscillating weight and the weight are integrally molded by a heavy metal firing (for example, refer to JP-UM-A-2-144789 (Patent Reference 1) and JP-A-2000-131461 (Patent Reference 2)).

A watch or the like needs to secure a predetermined mechanical strength so as not to be damaged by an impact due to being dropped. However, as described in Patent References 1 and 2, in the case where the body of the oscillating weight and the weight are integrally molded by the heavy metal firing, although it is expected that the winding efficiency is improved, since spring property to the rotation center side is lost, there is a concern that the center side of the body of the oscillating weight may be damaged when a dropping impact is applied to it. In addition, the impact which is applied to the weight is transferred to a train wheel as it is, and there is a concern that this affects the accuracy of the timepiece.

Thereby, a technology which separates the body of the oscillating weight and the weight and integrates them by laser welding has been suggested (for example, refer JP-A-2000-65962 (Patent Reference 3)).

However, in the Patent Reference 3, the portion to which the laser welding is applied is discolored and the aesthetic appearance is damaged. Thereby, for example, it is also considered that the body of the oscillating weight and the weight are fixed separately by using a fixing member such as screws. However, there is a problem in that the fixing member is conspicuous and the appearance is deteriorated. Particularly, in timepiece parts, there are many cases where coloring is performed on the parts and uniformity of the appearance in the fixing portion between parts is needed in order to improve the decorativeness of the product.

In addition, in order to make the fixing member inconspicuous, it is considered that plating is applied to the fixing member. However, there are problems in that peeling of the plating, aging deterioration due to a pinhole, damage to the aesthetic appearance due to mismatching of a tone of color with the body of the oscillating weight may occur.

### SUMMARY OF THE INVENTION

It is an aspect of the application to provide a decorative part, a timepiece, and a manufacturing method of the decorative part capable of stabilizing and improving aesthetic appearance while using a fixing member.

In a decorative part according to the present application, the decorative part includes a member to be fixed and a fixing member for fixing the member to be fixed to an object, wherein the member to be fixed and the fixing member are members to which anodizing can be applied.

According to the configuration, an uneven hue between the member to be fixed and the fixing member can be suppressed. In addition, by performing anodizing on the member to be fixed and the fixing member, the member to be fixed and the fixing member can be colored with a stable quality, and the decorative part having an excellent appearance quality can be provided.

In the decorative part according to the present application, the member to be fixed and the fixing member may be formed of either titanium or titanium alloy.

According to the configuration, impact resistance or vibration absorption against dropping or the like of the decorative part can be enhanced. In addition, since the decorative part can acquire sufficient corrosion resistance, rust prevention processing, which is needed in the case like, for example, iron, is not needed to be performed. In addition, aging deterioration in the quality can be suppressed. Therefore, the decorative part which has high quality and reliability can be provided.

In the decorative part according to the present application, a smooth surface which is smoothed by a mechanical processing may be formed on the same plane surface of each of the member to be fixed and the fixing member.

According to the configuration, it is further possible to make the fixing member inconspicuous. Therefore, the decorative part having a more excellent appearance quality can be provided.

In the decorative part according to the present application, the fixing member and the member to be fixed may be colored by anodizing after the member to be fixed is fixed by using the fixing member.

According to the configuration, the decorative part having an excellent aesthetic appearance can be provided. In addition, due to the fact that the decorative part is colored by anodizing, aging deterioration of the hue or peeling can be prevented. Moreover, since the anodic oxide film is a nano-order film, dimensional change of the part can be sufficiently suppressed.

In the decorative part according to the present application, one surface and the other surface of the surfaces of the member to be fixed may be colored by different hues.

According to the configuration, the decorative part having various variations of hue can be provided, and a product corresponding to the demands of users can be provided.

In the decorative part according to the present application, the member to be fixed may be a body of an oscillating weight, and the body of the oscillating weight may be fixed to a weight which is the object by using the fixing member.

According to the configuration, the oscillating weight having an excellent aesthetic appearance can be provided.

A timepiece according to the present application includes the decorative part described in any one of claims 1 to 6.

According to the configuration, the timepiece capable of stabilizing and improving the aesthetic appearance while using the fixing member can be provided.

In a manufacturing method of a decorative part according to the present application in which the decorative part includes a member to be fixed and a fixing member for fixing the member to be fixed to an object, the manufacturing method includes a fixing member mounting process that mounts the fixing member to the member to be fixed, an anodizing process that performs anodizing on the member to be fixed and the fixing member which are integrated by the fixing member mounting process, and a fixing process that fixes the member to be fixed to the object by using the fixing member after undergoing the anodizing process.

According to the method, an uneven hue of the member to be fixed and the fixing member can be suppressed, and it is possible to color the member to be fixed and the fixing member with a stable quality. Therefore, the decorative part having an excellent appearance quality can be provided.

The manufacturing method of the decorative part according to the present application may further include a smooth surface forming process that forms a smooth surface on the same plane surface of each of the member to be fixed and the fixing member by a mechanical processing in the fixing member mounting process.

According to the method, it is further possible to make the fixing member inconspicuous. Therefore, the decorative part having a more excellent appearance quality can be provided.

In the manufacturing method of a decorative part according to the present application in which the decorative part includes a member to be fixed and a fixing member for fixing the member to be fixed to an object, the manufacturing method includes a fixing member mounting process that mounts the fixing member to the member to be fixed, a first anodizing process that performs anodizing on the member to be fixed and the fixing member which are integrated by the fixing member mounting process and forms a first anodic oxide film, an oxide film removing process that removes the first anodic oxide film which is formed on one surface of the fixing member and the member to be fixed after undergoing the first anodizing process, a second anodizing process that performs anodizing again on the fixing member and the member to be fixed and forms a second anodic oxide film on the one surface after undergoing the oxide film removing process, and a fixing process that fixes the member to be fixed to the object by using the fixing member after undergoing the second anodizing process.

According to the method, an uneven hue between the member to be fixed and the fixing member can be suppressed, and variation in the hue can be increased.

According to the present application, an uneven hue between the member to be fixed and the fixing member can be suppressed. In addition, by performing anodizing on the member to be fixed and the fixing member, the member to be fixed and the fixing member can be colored with a stable quality, and peeling can be suppressed. Therefore, the decorative part having an excellent appearance quality can be provided.

### BRIEF DESCRIPTION OF THE DRAWINGS

FIG. 1 is a plan view when viewing a movement from the front side in a state where an automatic winding mechanism according to a first embodiment of the present invention is removed;

FIG. 2 is a schematic configuration illustrating the automatic winding mechanism according to the first embodiment of the present invention;

FIG. 3 is a plan view illustrating an oscillating weight according to the first embodiment of the present invention;

FIG. 4 is a longitudinal cross-sectional view illustrating the oscillating weight according to the first embodiment of the present invention;

FIG. 5 is a longitudinal sectional view illustrating a body of an oscillating weight and screws according to the first embodiment of the present invention;

FIGS. 6A to 6D are explanatory views illustrating a manufacturing method of the body of the oscillating weight and a weight according to the first embodiment of the present invention, and FIGS. 6A to 6D illustrate each process;

FIGS. 7A to 7D are explanatory views illustrating a modification in a manufacturing method of the body of the oscillating weight and the weight according to the present invention, and FIGS. 7A to 7D illustrate each process;

FIG. 8 is a longitudinal cross-sectional view illustrating an oscillating weight according to a second embodiment of the present invention;

FIG. 9 is a longitudinal cross-sectional view illustrating an oscillating weight according to a third embodiment of the present invention;

FIG. 10 is a plan view illustrating a C-type snap ring according to the third embodiment of the present invention; and

FIG. 11 is a longitudinal cross-sectional view illustrating an oscillating weight according to a fourth embodiment of the present invention.

### DETAILED DESCRIPTION OF THE PREFERRED EMBODIMENTS

### First Embodiment

### (Automatic Winding Watch)

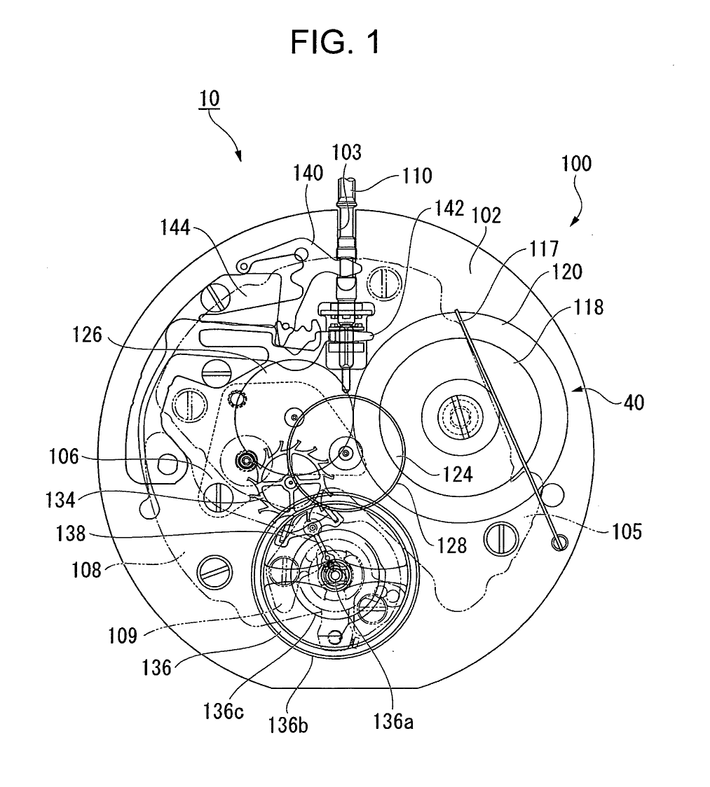

Next, a first embodiment of the present invention will be described based on FIGS. 1 to 5.

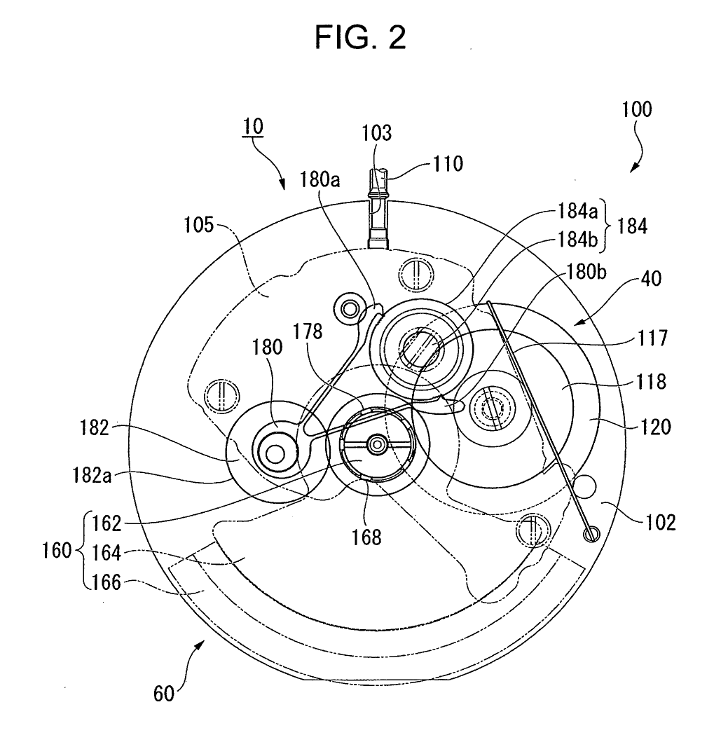

FIG. 1 is a plan view when viewing a movement from the front side in a state where an automatic winding mechanism is removed, and FIG. 2 is a schematic configuration illustrating the automatic winding mechanism.

As illustrated in FIGS. 1 and 2, the automatic winding watch 10 into which a decorative part according to the present invention (for example, an oscillating weight 160 described below) is built is constituted by a movement 100 and a casing (not illustrated) which houses the movement 100. In addition, a dial (not illustrated) is mounted on the movement 100. The movement 100 includes a main plate 102 which constitutes a substrate, a barrel and train wheel bridge 105, a center wheel bridge 106, a balance bridge 108, and a pallet bridge 109. The center wheel bridge 106 is disposed between the barrel and train wheel bridge 105 and the main plate 102. A winding stem guide hole 103 is formed at the main plate 102, and a winding stem 110 is rotatably built into the winding stem guide hole.

Here, in both sides of the main plate 102, a side (the rear of the paper surface in FIGS. 1 and 2) in which the dial is disposed is referred to as an rear side of the movement 100, and a side (in front of the paper surface in FIGS. 1 and 2) opposite to the side in which the dial is disposed is referred to as a front side of the movement 100. A switching device including a train wheel referred to as a back train wheel or, a setting lever 140, a yoke 142, and a setting lever spring 144 is disposed in the rear side of the movement 100. A position in a shaft direction of the winding stem 110 is determined by the switching device.

On the other hand, a train wheel referred to as a front train wheel, an escapement and regulating device 40 for controlling the rotation of the front train wheel, an automatic winding mechanism 60, and the like are built into the front side of the movement 100.

The front train wheel is constituted by a movement barrel wheel 120, a center wheel & pinion 124, a third wheel & pinion 126, and a second wheel & pinion 128. The movement barrel wheel 120 is rotatably supported by the barrel and train wheel bridge 105 and the main plate 102, and includes a mainspring (not illustrated). In addition, if the winding stem 110 is rotated, a clutch wheel (not illustrated) is rotated. Further, the mainspring is wound up via a winding pinion, a crown wheel (none are illustrated), and a ratchet wheel 118.

Moreover, a plate-shaped click 117 is meshed in a tooth section of the ratchet wheel 118, and therefore, the rotation of the ratchet wheel 118 is regulated.

On the other hand, the movement barrel wheel 120 is rotated by the rotation force generated when the mainspring is wound up, and the center wheel & pinion 124 is rotated. The center wheel & pinion 124 is rotatably supported by the center wheel bridge 106 and the main plate 102. If the center wheel & pinion 124 is rotated, the third wheel & pinion 126 is rotated.

The third wheel & pinion 126 is rotatably supported by the barrel and train wheel bridge 105 and the main plate 102. If the third wheel & pinion 126 is rotated, the second wheel & pinion 128 is rotated. The second wheel & pinion 128 is rotatably supported by the barrel and train wheel bridge 105 and the center wheel bridge 106. Due to the fact that the second wheel & pinion 128 is rotated, the escapement and regulating device 40 is driven.

### (Escapement and Regulating Device)

The escapement and regulating device 40 includes a balance with hairspring 136, an escape wheel & pinion 134, and a pallet fork 138. The pallet fork 138 is rotatably supported by the pallet bridge 109 and the main plate 102. The balance with hairspring 136 is rotatably supported by the balance bridge 108 and the main plate 102. The balance with hairspring 136 includes a balance staff 136a, a balance wheel 136b, and a hairspring 136c.

According to the configuration, the escapement and regulating device 40 controls the center wheel & pinion 124 to be rotated once per hour. A cannon pinion (not illustrated) is constituted so as to simultaneously rotate based on the rotation of the center wheel & pinion 124, and a minute hand (not illustrated) which is mounted on the cannon pinion indicates the “minute”.

Moreover, in the cannon pinion, a slip mechanism is installed with respect to the center wheel & pinion 124. Through the rotation of a minute wheel based on the rotation of the cannon pinion, an hour wheel (none are illustrated) is constituted to rotate once every 12 hours. In addition, an hour hand (not illustrated) which is mounted on the hour wheel indicates the “hour”.

Moreover, through the rotation of the third wheel & pinion 126 by the rotation of the center wheel & pinion 124, the second wheel & pinion 128 is constituted to rotate once by one minute. A second hand (not illustrated) is mounted on the second wheel & pinion 128.

### (Automatic Winding Mechanism)

In the automatic winding mechanism 60, the oscillating weight 160 constituting the automatic winding mechanism 60 is moved by movement of an arm of a user, and a mainspring (not illustrated) of the movement barrel wheel 120 is wound up. In addition, the oscillating weight 160 has a role which winds a mainspring (not illustrated) and a role which is the decorative part constituting the appearance of the automatic winding watch 10 in a case where a casing (not illustrated) is formed of a transparent member or the like.

The oscillating weight 160 includes a ball bearing 162, a body 164 of an oscillating weight, and a weight 166. The ball bearing 162 includes an inner race, an outer race, and a plurality of balls (none are illustrated) which is installed between the outer race and the inner race, and the inner race is fixed to the barrel and train wheel bridge 105 via a ball bearing locking screw 168.

### (Body of Oscillating Weight and Weight)

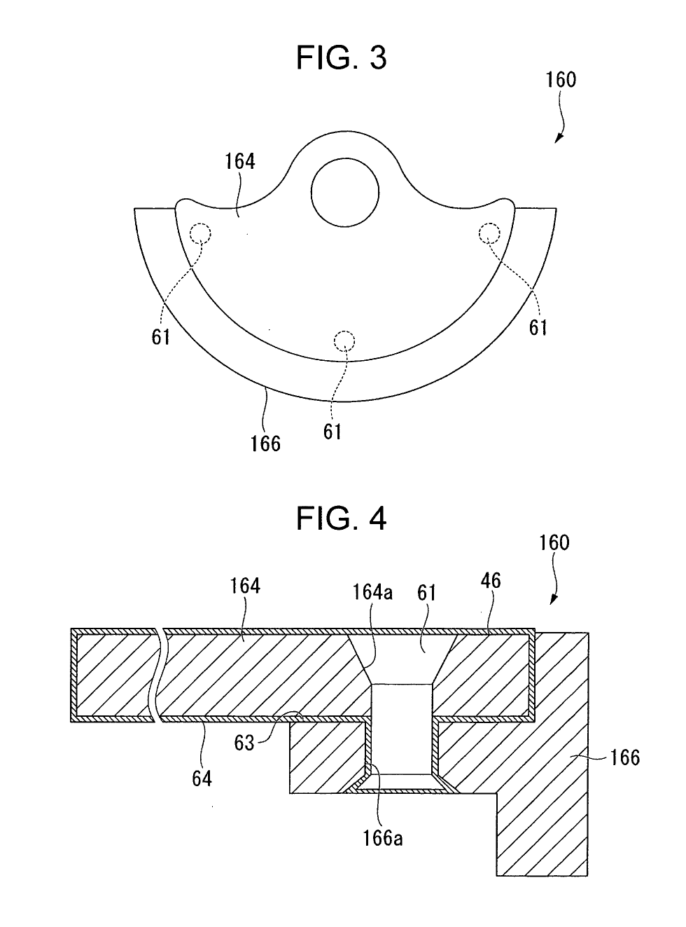

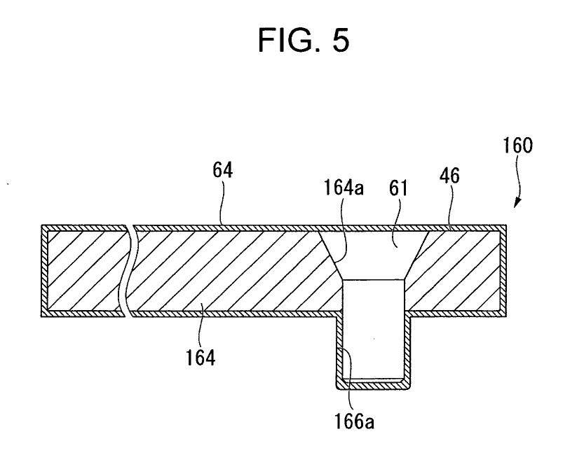

FIG. 3 is a plan view illustrating the oscillating weight, FIG. 4 is a longitudinal cross-sectional view illustrating the oscillating weight, and FIG. 5 is a longitudinal cross-sectional view illustrating the body of the oscillating weight and the screws.

As illustrated in FIGS. 2 to 5, the body 164 of the oscillating weight of the oscillating weight 160 is formed in a substantial fan-shape in plan view by either titanium (Ti) or titanium alloy to which anodizing can be applied. The ball bearing 162 is disposed on a rotation center of the body 164 of the oscillating weight, and the outer race of the ball bearing 162 and the body 164 of the oscillating weight are fixed to each other.

In addition, the weight 166 is fixed to the outer peripheral edge of the body 164 of the oscillating weight through screws 61 as the fixing member. Similarly to the body 164 of the oscillating weight, the screws 61 are formed of either titanium or titanium alloy to which anodizing can be applied. Here, it is preferable that the body 164 of the oscillating weight and the screws 61 are of the same material. That is, in the case where the body 164 of the oscillating weight is formed of titanium, the screws 61 are also formed of titanium. Moreover, in the case where the body 164 of the oscillating weight is formed of titanium alloy, the screws 61 are also formed of titanium alloy.

As illustrated in detail in FIG. 5, a plurality of (three in the first embodiment) through-holes 164a to which the screws 61 can be inserted are formed on an outer periphery 46 of the body 164 of the oscillating weight . The screws 61 are inserted in advance into the each through-holes 164a and integrated. Moreover, in the integrated state, an anodic oxide film 64 is formed in advance on the surface of the body 164 of the oscillating weight and the place to which the screws 61 are exposed, and the entire is colored. The anodic oxide film 64 is applied with a sufficient thickness, for example, by a range of tens to hundreds of μm. The manufacturing method will be described below.

On the other hand, the weight 166 is formed by molding and firing a compound which has heavy metal powder as the main component, for example, a powder which contains nickel (Ni) or copper (Cu) together with tungsten (W). Moreover, brass may be used.

The weight 166 is curved so as to correspond to the outer peripheral edge of the body 164 of the oscillating weight, and includes a bearing surface 63a on which the body 164 of the oscillating weight can be set on and an outer peripheral wall 63b which is formed so as to be erected at the outer periphery of the bearing surface 63a and covers the outer peripheral edge of the body 164 of the oscillating weight. Through-holes 166a to which the screws 61 can be inserted is formed at the place corresponding to the through-holes 164a of the body 164 of the oscillating weight in the bearing surface 63a.

According to the configuration, the screws 61 are integrated with the bearing surface 63a of the weight 166, the outer periphery 46 of the body 164 of the oscillating weight in which the anodic oxide film 64 is formed on the surface is placed, and the screws 61 are inserted into the through-holes 166a of the weight 166. Thereafter, the body 164 of the oscillating weight and the weight 166 are integrated by buckle-deforming the tips of the screws 61.

Return to FIG. 2, an oscillating weight pinion 178 is installed in the outer race of the ball bearing 162. The oscillating weight pinion 178 is meshed with the transmission wheel gear 182a of the first transmission wheel 182. The first transmission gear 182a is rotatably supported by the barrel and train wheel bridge 105 and the main plate 102. In addition, a pawl lever 180 is built between the first transmission wheel 182 and the barrel and train wheel bridge 105. The pawl lever 180 is mounted in a shape which is eccentric from a shaft center of the first transmission wheel 182, and includes a pulling claw 180a and a pushing claw 180b. The pulling claw 180a and the pushing claw 180b are meshed with a second transmission gear 184a of a second transmission wheel 184.

The second transmission wheel 184 includes a second transmission pinion 184b in addition to the second transmission gear 184a. The second transmission gear 184a is disposed between the body 164 of the oscillating weight and the barrel and train wheel bridge 105. On the other hand, the second transmission pinion 184b is meshed with the ratchet wheel 118.

In addition, the pulling claw 180a and the pushing claw 180b of the pawl lever 180 which is meshed with the second transmission gear 184a are biased toward the center of the second transmission gear 184a by elastic force.

According to the configuration, if the oscillating weight 160 is rotated, the oscillating weight pinion 178 is also rotated simultaneously, and the first transmission wheel 182 is rotated by the rotation of the oscillating weight pinion 178. The pawl lever 180, which is mounted in a shape which is eccentric from the shaft center of the first transmission wheel 182, performs a reciprocating movement by the rotation of the first transmission wheel 182. In addition, the second transmission wheel 184 is rotated in a constant direction by the pulling claw 180a and the pushing claw 180b. Thereby, the ratchet wheel 118 is rotated by the rotation of the second transmission wheel 184, and a mainspring (not illustrated) of the movement barrel wheel 120 is wound up.

### (Manufacturing Method of Body of Oscillating Weight and Weight)

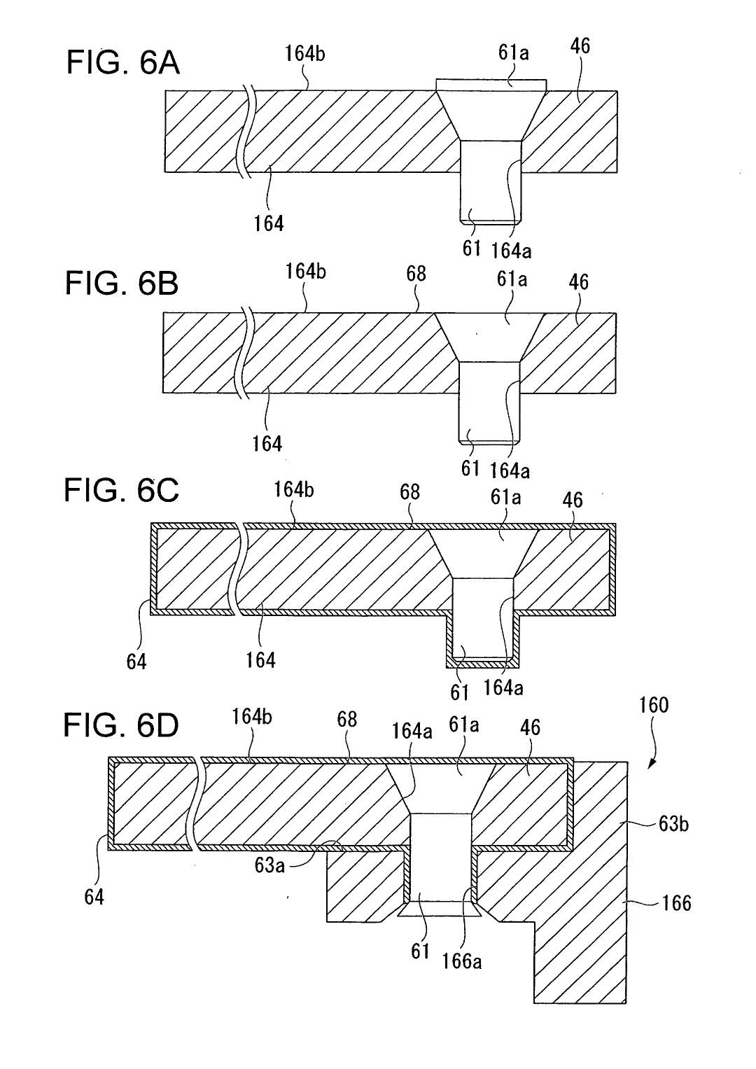

Next, based on FIGS. 6A to 6D, the manufacturing method of the body 164 of the oscillating weight and weight 166 in the oscillating weight will be described. FIGS. 6A to 6D are explanatory views illustrating the manufacturing method of the body of the oscillating weight and the weight, and FIGS. 6A to 6D illustrate each process.

First, as illustrated in FIG. 6A, the screws 61 are inserted into the through-holes 164a of the body 164 of the oscillating weight (fixing member mounting process) . At this time, due to a manufacturing error of the body 164 of the oscillating weight or the screws 61, there is a case where the head portions 61a of the screws 61 are protruded from one surface 164b of the body 164 of the oscillating weight or are concave from the surface.

In FIG. 6A, the state where the screws 61 are protruded from one surface 164b of the body 164 of the oscillating weight is illustrated. In FIG. 6A, in order to easily illustrate the protruded state of the screws 61, the scale is appropriately changed.

Next, as illustrated in FIG. 6B, one surface 164b of the body 164 of the oscillating weight and the head portions 61a of the screws 61, which are on the same plane surface, are ground by a mechanical processing, and one surface 164b of the body 164 of the oscillating weight and the head portions 61a of the screws 61 are smoothed. Thereby, a smooth surface 68 is formed on one surface 164b of the body 164 of the oscillating weight and on the head portions 61a of the screws 61 so that one surface 164b and the head portion 61a are flush with each other (smooth surface forming process). In addition, due to the fact that the smooth surface 68 is formed, the boundary line between the body 164 of the oscillating weight and the screws 61 becomes inconspicuous.

Next, as illustrated in FIG. 6C, the anodizing is performed in the state where the body 164 of the oscillating weight and the screws 61 are integrated (anodizing process).

Specifically, for example, a titanium plate is immersed in an electrolytic solution of a phosphoric acid aqueous solution and becomes a cathode. Moreover, the integrated body 164 of the oscillating weight and the screws 61 is immersed, and electrolytic voltage is applied and it becomes an anode. Thereby, the anodic oxide film 64 of a titanium oxide is formed on the surface of the body 164 of the oscillating weight and the portion to which the screws 61 are exposed, and the body 164 of the oscillating weight and the screws 61 are colored. At this time, since the body 164 of the oscillating weight and the screws 61 are formed of the same member, a uniform anodic oxide film 64 is formed on the entire body 164 of the oscillating weight and the screws 61, and an uneven hue is not generated.

Next, as illustrated in FIG. 6D, the outer periphery 46 of the body 164 of the oscillating weight is placed on the bearing surface 63a of the weight 166, and the screws 61 are inserted into the through-holes 166a of the weight 166. Thereafter, the body 164 of the oscillating weight is fixed to the weight 166 by buckle-deforming the tips of the screws 61 (fixing process) . At this time, a gap may be formed between the body 164 of the oscillating weight and the weight 166, and both 164 and 166 may be completely adhered to each other.

### Effect

Therefore, according to the first embodiment, an uneven hue between the body 164 of the oscillating weight and the screws 61 can be suppressed, and the screws 61 can be inconspicuous. Moreover, since the anodic oxide film 64 is formed on the body 164 of the oscillating weight and the screws 61 and colored, the quality of the aesthetic appearance can be stabilized. In addition, since the coloring is performed by anodizing, aging deterioration of the hue or peeling can be prevented. Moreover, since the anodic oxide film 64 is a nano-order film, dimensional change of the part can be sufficiently suppressed. Thereby, the oscillating weight 160 which has a high manufacturing accuracy and high designability even when the body 164 of the oscillating weight is fixed by using the screws 61 can be provided.

In addition, since the body 164 of the oscillating weight or the screws 61 is formed of either titanium or titanium alloy, impact resistance or vibration absorption against dropping or the like of the oscillating weight 160 can be enhanced. Moreover, since the oscillating weight can obtain sufficient corrosion resistance, rust prevention processing, which is needed in the case like, for example, iron, is not needed to be performed. In addition, aging deterioration in the quality can be suppressed.

In addition, after the screws 61 are inserted into the through-holes 164a of the body 164 of the oscillating weight, one surface 164b of the body 164 of the oscillating weight and the head portions 61a of the screws 61 are ground by a mechanical processing, and the smooth surface 68 is formed so that one surface 164b and the head portion 61a are flush with each other. Thereby, it is further possible to make the screws 61 inconspicuous, and the oscillating weight 160 having a more excellent appearance quality can be provided.

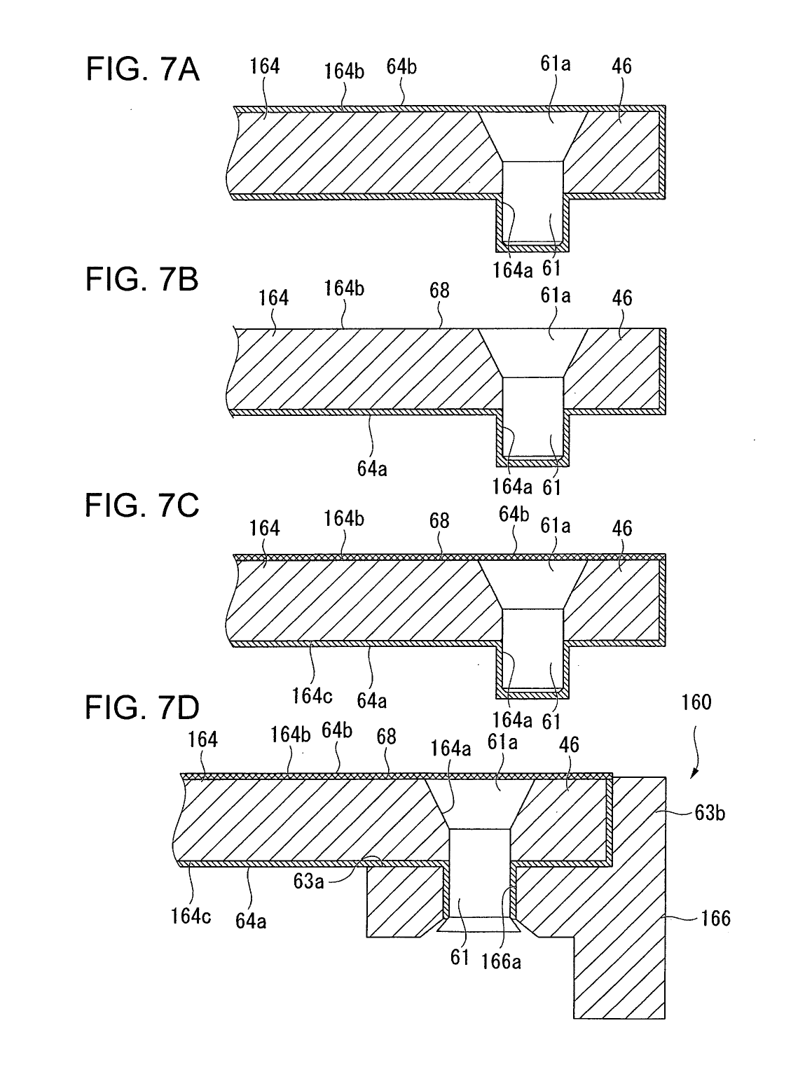

Moreover, in the above-described first embodiment, the case where the uniform anodic oxide film 64 is formed on the entire of the body 164 of the oscillating weight and the screws 61 is described. However, the invention is not limited to this . That is, the film thickness of the anodic oxide film 64 can be changed at the front surface and the rear surface of the body 164 of the oscillating weight respectively. More specifically, based on FIGS. 7A to 7D below, the manufacturing method in which the film thickness of the anodic oxide film 64 is changed on the front surface and the rear surface of the body 164 of the oscillating weight respectively will be described.

### Modification of First Embodiment

FIGS. 7A to 7D are explanatory views illustrating the manufacturing method of the body of the oscillating weight and the weight, and FIGS. 7A to 7D illustrate each process. Moreover, in the description below, since the fixing member mounting process in which the screws 61 are inserted into the through-holes 164a of the body 164 of the oscillating weight and the smooth surface forming process in which one surface 164b of the body 164 of the oscillating weight and the head portions 61a of the screws 61 are smoothed are similar to those of the above-described first embodiment, the description is omitted.

Here, two processes of a first anodizing process and a second anodizing process are performed on the body 164 of the oscillating weight and the screws 61.

That is, first, as illustrated in FIG. 7A, a first anodizing process is preformed on the body 164 of the oscillating weight and the screws 61 that have undergone the smooth surface forming process, and a high pressure anodic oxide film 64a which has a uniform film thickness is formed on the entire body 164 of the oscillating weight and the screws 61. The value of the electrolytic voltage applied in the first anodizing process is set to be higher than that of the second anodizing process which is the later process.

Next, as illustrated in FIG. 7B, the high pressure anodic oxide film 64a formed on the smooth surface 68 of the body 164 of the oscillating weight and the screws 61 is removed by a physical method (oxide film removing process).

Thereafter, the second anodizing is performed on the body 164 of the oscillating weight and the screws 61. At this time, the value of the electrolytic voltage in the second anodizing process is smaller than the value of the electrolytic voltage in the first anodizing process. Thereby, a new oxide film is not formed on the high pressure anodic oxide film 64a formed in the first anodizing process.

On the other hand, as illustrated in FIG. 7C, a new low pressure anodic oxide film 64b is formed on the smooth surface 68 from which the high pressure anodic oxide film 64a is removed by the physical method. The low pressure anodic oxide film 64b becomes a thinner film compared to the high pressure anodic oxide film 64a by the value of the electrolytic voltage which is lower in the second anodizing process. Thereby, the film thicknesses of the anodic oxide films 64a and 64b can be changed at the front surface and the rear surface of the body 164 of the oscillating weight, that is, one surface 164b and the other surface 164c respectively.

Thereafter, as illustrated in FIG. 7D, the outer periphery 46 of the body 164 of the oscillating weight is placed on the bearing surface 63a of the weight 166, and the screws 61 are inserted into the through-holes 166a of the weight 166. Thereafter, the tip of the screws 61 are buckle-deformed, and therefore, the body 164 of the oscillating weight is fixed to the weight 166 (fixing process) . At this time, a gap may be formed between the body 164 of the oscillating weight and the weight 166, and both 164 and 166 may be completely adhered to each other.

Therefore, according to the above-described modification of the first embodiment, in addition to those effects similar to the above-described first embodiment, the hue of each of the front and rear surfaces of the body 164 of the oscillating weight can be changed by changing the film thicknesses of the anodic oxide films 64a and 64b. Thereby, the oscillating weight 160 having various variations of hue can be provided, and products according to the needs of users can be provided.

### Second Embodiment

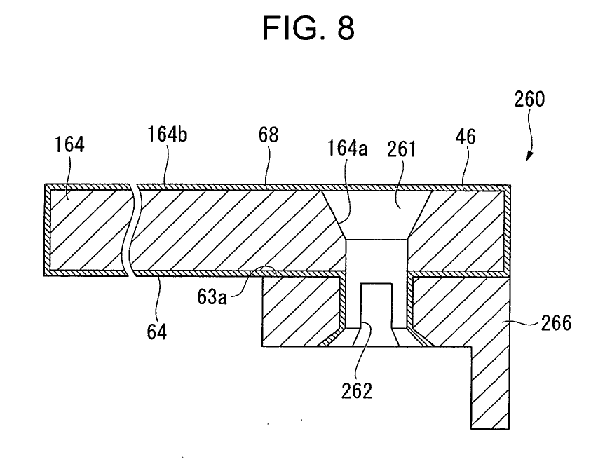

Next, a second embodiment of the invention will be described based on FIG. 8 while referring to the FIGS. 1 and 2. In addition, the same reference numbers are denoted to parts similar to those of the first embodiment and described (similarly applied also to embodiments hereinafter).

FIG. 8 is a longitudinal cross-section illustrating an oscillating weight according to the second embodiment.

In the second embodiment, basic configurations such as the configuration in which the automatic winding watch 10 includes the movement 100, and the train wheel referred to as the front train wheel, and the escapement and regulating device 40 for controlling the rotation of the front train wheel, the automatic winding mechanism 60, or the like are built into the front side of the movement 100, the configuration in which the oscillating weight 260 of the automatic winding mechanism 60 includes ball bearings 162, the body 164 of the oscillating weight, and the weight 266, and the body 164 of the oscillating weight and the weight 266 are fixed through the screws 261, the configuration in which the body 164 of the oscillating weight and the screws 261 are formed of either titanium or titanium alloy to which the anodizing can be applied, and the configuration in which the anodizing is performed in advance in the state where the body 164 of the oscillating weight and the screws 261 are integrated and thereafter, the body 164 of the oscillating weight is fixed to the weight 266 are similar to those of the above-described first embodiment (similarly applied also to embodiments hereinafter).

Here, as illustrated in FIG. 8, the difference between the second embodiment and the first embodiment is that the shape of the screws 261 is different. That is, in the screws 261 of the second embodiment, a concave portion for caulking 262 is formed at the tips of the screws 261. Due to the fact that the concave portion for caulking 262 is formed, the rigidity of the tips of the screws 261 becomes weak, and the diameter of the tip is easily deformed to be expanded.

Therefore, according to the above-described second embodiment, in addition to those effects similar to the above-described first embodiment, assembly workability can be improved due to the fact that the tips of the screws 261 can be easily deformed.

The weight 266 of the second embodiment is curved so as to correspond to the outer peripheral edge of the body 164 of the oscillating weight. However, the weight 266 of the second embodiment does not have an outer peripheral wall which covers the outer peripheral edge of the body 164 of the oscillating weight, and has only the bearing surface 63a capable of placing the body 164 of the oscillating weight (similarly applied also to embodiments hereinafter). In this way, the weight 266 may be constituted to be mounted only on the surface of the side (lower surface in FIG. 8) opposite to the one surface 164b of the body 164 of the oscillating weight.

### Third Embodiment

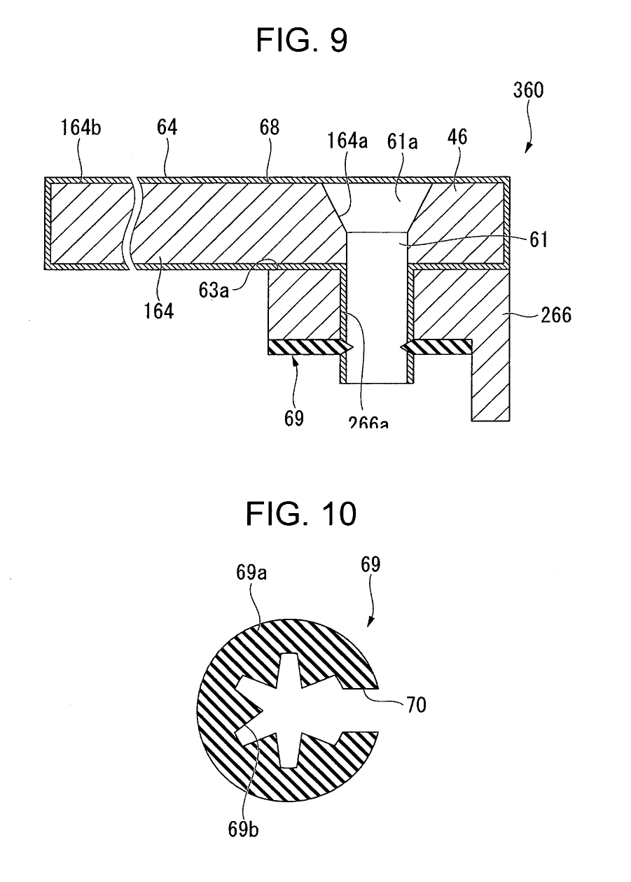

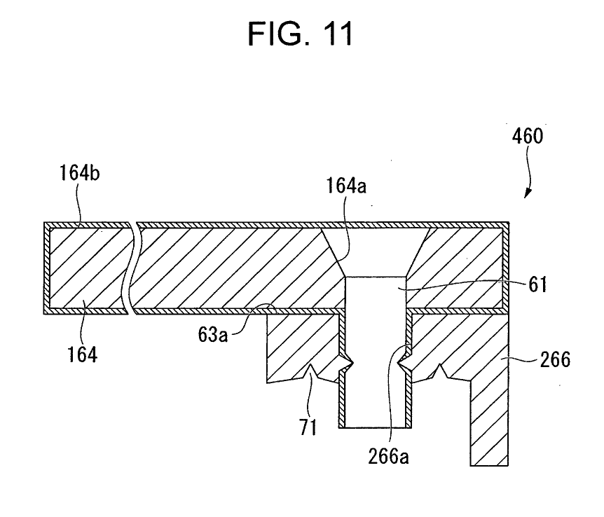

Next, a third embodiment of the invention will be described based on FIGS. 9 and 10.

FIG. 9 is a longitudinal cross-sectional view illustrating an oscillating weight according to the third embodiment.

As illustrated in FIG. 9, the difference between the third embodiment and the above-described second embodiment is that the fixing methods of the body 164 of the oscillating weight with respect to the weight 266 are different from each other. That is, the oscillating weight 360 includes the body 164 of the oscillating weight and the weight 266, and the body 164 of the oscillating weight and the weight 266 are fixed to each other by the screws 61 which is inserted into the through-holes 164a of the body 164 of the oscillating weights and the through-holes 266a of the weight 266 and a C-type snap ring 69 which can be engaged to the screws 61.

FIG. 10 is a plan view illustrating the C-type snap ring.

As illustrated in FIG. 10, in the C-type snap ring 69, a C-shaped ring portion 69a and a tooth section 69b which is protruded to the inner peripheral edge of the C-shaped ring portion 69a are integrally formed. In the C-shaped ring portion 69a, a notch 70 in which the inner portion and the outer portion in the radial direction communicate with each other is formed. By expanding the notch 70, the diameter of the C-shaped ring portion 69a is deformed to be expanded.

In addition, the tooth section 69b is constituted to be elastically deformed and can be engaged to the outer peripheral surface of the screws 61.

According to the configuration, the outer periphery 46 of the body 164 of the oscillating weight is placed on the bearing surface 63a of the weight 266, and the screws 61 are inserted into the through-holes 266a of the weight 266. Thereafter, the C-type snap ring 69 is mounted on the tips of the screws 61 from the outside in the radial direction of the screws 61.

Specifically, the notch 70 of the C-shaped ring portion 69a is expanded and the diameter of the ring portion is deformed to be expanded, and the C-type snap ring 69 is mounted by the screws 61 are inserted from the outside in the radial direction. Thereby, the tooth section 69b of the C-type snap ring 69 is wedged to the screws 61, and the screws 61 and the C-type snap ring 69 are engaged to each other. In addition, the falling out direction of the screws 61 is regulated by the C-type snap ring 69.

Here, since the C-type snap ring 69 is mounted on the tips of the screws 61 from the outside in the radial direction of the screws, the anodic oxide film 64 formed on the screws 61 is hardly damaged.

Thereby, according to the above-described third embodiment, those effects similar to the above-described first embodiment can be achieved.

In the above-described third embodiment, the case where the C-shaped ring portion 69a and the tooth section 69b which is protruded to the inner peripheral edge of the C-shaped ring portion 69a are integrally formed in the C-type snap ring 69 is described. However, the invention is not limited to this. That is, only the C-shaped ring portion 69a may be formed in the C-type snap ring 69. In this case, a groove for receiving the C-type snap ring 69 is formed at the tips of the screws 61.

### Fourth Embodiment

Next, a fourth embodiment of the invention will be described based on FIG. 11.

FIG. 11 is a longitudinal cross-sectional view illustrating an oscillating weight according to the fourth embodiment.

As illustrated in FIG. 11, the difference between the fourth embodiment and the above-described first embodiment is that the body 164 of the oscillating weight and the weight 266 are fixed to each other by deforming a weight 266 in an oscillating weight 460 of the fourth embodiment while the body 164 of the oscillating weight and the weight 166 are fixed to each other by buckle-deforming the tips of the screws 61 in the oscillating weight 160 of the first embodiment.

That is, in the weight 266, a tool driving portion 71 is formed so as to surround the periphery of the through-hole 266a in the rear side of the bearing surface 63a. In addition, if a tool (not illustrated) is driven to the tool driving portion 71, the through-hole 266a is deformed toward the shaft center side and bites into the outer peripheral surface of the screws 61.

Also in the case of the above configuration, those effects similar to the above-described first embodiment can be achieved.

Moreover, the present invention is not limited to the above-described embodiments, and includes those in which various alterations are applied to the above-described embodiments within the range without departing from the gist of the present invention.

For example, in the above-described embodiments, the case where the body 164 of the oscillating weight and the screws 61 and 261 are formed of either titanium or titanium alloy is described. However, the invention is not limited to this. That is, the body 164 of the oscillating weight and the screws 61 and 261 may be formed of any member if at least anodizing can be applied thereto. For example, metal materials such as magnesium (Mg), magnesium alloy, lithium (Li), aluminum (Al), tungsten, molybdenum (Mo) may be used instead of titanium and titanium alloy.

In addition, in the above-described embodiments, the case where one surface 164b of the body 164 of the oscillating weight and the head portions 61a of the screws 61 are ground by a mechanical processing after the screws 61 are inserted into the through-holes 164a of the body 164 of the oscillating weight and the smooth surface 68 is formed is described. However, the invention is not limited to this. That is, anodizing may be performed on the body 164 of the oscillating weight and the screws 61 without smoothing one surface 164b of the body 164 of the oscillating weight and the head portions 61a of the screws 61. Also in the case of the configuration, due to the fact that the member forming the body 164 of the oscillating weight and the member forming the screws 61 are completely the same or substantially the same with each other, the hues of both 164 and 61 can be matched to each other, and it is possible to make the screws 61 inconspicuous.

Moreover, in the above-described embodiments, the case where the screws 61 and 262 are used as the fixing member for fixing the body 164 of the oscillating weight to the weights 166 and 266 is described. However, the fixing member is not limited to the screws 61 and 262. That is, any member may be used if the body 164 of the oscillating weight can be fixed to the weights 166 and 266 and the anodizing can be applied thereto. For example, a bolt maybe used instead of the screws 61 and 262.

In addition, in the above-described embodiments, the case where the body 164 of the oscillating weight which is built into the movement 100 of the automatic winding watch 10 and is the member to be fixed and the screws 61 and 261 which are the fixing members in order to fix the body 164 of the oscillating weight to the weights 166 and 266 which are the objects are used, and anodizing is performed on the body 164 of the oscillating weight and the screws 61 and 261 which are the member to which anodizing can be applied is described. However, the invention is not limited to this. That is, the above-described embodiment can be adapted with respect to various decorative parts in which the member to be fixed is fixed to the object through the fixing member.

What is claimed is:

1. A decorative part which includes a member to be fixed and a fixing member for fixing the member to be fixed to an object,
wherein the member to be fixed and the fixing member are a member to which anodizing can be applied.

2. The decorative part according to claim 1,
wherein the member to be fixed and the fixing member are formed of either titanium or titanium alloy.

3. The decorative part according to claim 1,
wherein a smooth surface which is smoothed by a mechanical processing is formed on the same plane surface of each of the member to be fixed and the fixing member.

4. The decorative part according to claim 2,
wherein a smooth surface which is smoothed by a mechanical processing is formed on the same plane surface of each of the member to be fixed and the fixing member.

5. The decorative part according to claim 1,
wherein the fixing member and the member to be fixed are colored by the anodizing after the member to be fixed is fixed by using the fixing member.

6. The decorative part according to claim 2,
wherein the fixing member and the member to be fixed are colored by the anodizing after the member to be fixed is fixed by using the fixing member.

7. The decorative part according to claim 3,
wherein the fixing member and the member to be fixed are colored by the anodizing after the member to be fixed is fixed by using the fixing member.

8. The decorative part according to claim 4,
wherein the fixing member and the member to be fixed are colored by the anodizing after the member to be fixed is fixed by using the fixing member.

9. The decorative part according to claim 5,
wherein one surface and the other surface in surfaces of the member to be fixed are colored by different hues.

10. The decorative part according to claim 6,
wherein one surface and the other surface in surfaces of the member to be fixed are colored by different hues.

11. The decorative part according to claim 7,
wherein one surface and the other surface in surfaces of the member to be fixed are colored by different hues.

12. The decorative part according to claim 8,
wherein one surface and the other surface in surfaces of the member to be fixed are colored by different hues.

13. The decorative part according to claim 1,
wherein the member to be fixed is a body of an oscillating weight, and the body of the oscillating weight is fixed to a weight which is the object by using the fixing member.

14. The decorative part according to claim 2,
wherein the member to be fixed is a body of an oscillating weight, and the body of the oscillating weight is fixed to a weight which is the object by using the fixing member.

15. The decorative part according to claim 3,
wherein the member to be fixed is a body of an oscillating weight, and the body of the oscillating weight is fixed to a weight which is the object by using the fixing member.

16. The decorative part according to claim 4,
wherein the member to be fixed is a body of an oscillating weight, and the body of the oscillating weight is fixed to a weight which is the object by using the fixing member.

17. A timepiece comprising the decorative part described in claim 1.

18. A manufacturing method of a decorative part in which the decorative part includes a member to be fixed and a fixing member for fixing the member to be fixed to an object, the manufacturing method comprising:
a fixing member mounting process that mounts the fixing member to the member to be fixed;
an anodizing process that performs anodizing on the member to be fixed and the fixing member which are integrated by the fixing member mounting process; and
a fixing process that fixes the member to be fixed to the object by using the fixing member after undergoing the anodizing process.

19. The manufacturing method of the decorative part according to claim 18,
wherein the manufacturing method further includes a smooth surface forming process that forms a smooth surface on the same plane surface of each of the member to be fixed and the fixing member by a mechanical processing in the fixing member mounting process.

20. A manufacturing method of a decorative part in which the decorative part includes a member to be fixed and a fixing member for fixing the member to be fixed to an object, the manufacturing method comprising:
a fixing member mounting process that mounts the fixing member to the member to be fixed;
a first anodizing process that performs anodizing on the member to be fixed and the fixing member which are integrated by the fixing member mounting process and forms a first anodic oxide film;
an oxide film removing process that removes the first anodic oxide film which is formed on one surface of the fixing member and the member to be fixed after undergoing the first anodizing process;
a second anodizing process that performs anodizing again on the fixing member and the member to be fixed and forms a second anodic oxide film on the one surface after undergoing the oxide film removing process; and
a fixing process that fixes the member to be fixed to the object by using the fixing member after undergoing the second anodizing process.
